(19) United States
(12) Patent Application Publication
(10) Pub. No.: US 2004/0140717 A1
(43) Pub. Date: Jul. 22, 2004

(54) Grouser assembly

(76) Inventors: Thomas McNutt, Libby, MT (US); Darby McNutt, Libby, MT (US); Steven Wolleat, Libby, MT (US); Paul Bache, Libby, MT (US)

Correspondence Address: Burkhart & Burkhart, Patent Attorneys, 940 Dakota Avenue, Whitefish, MT, 59937, US

(21) Appl. No.: 10/679,003

(22) Filed: Oct. 4, 2003

Related U.S. Application Data
(63) Continuation-in-part of application No. 10/313,877, filed on Dec. 5, 2002, now abandoned.

(51) Int. Cl. B62D 55/28

(52) U.S. Cl. 305/187

(57) ABSTRACT

A detachable grouser assembly for use with vehicles having continuous flexible tracks includes a traction grouser adapted and constructed to fit onto a track of the vehicle. A selectively releasable mechanical attachment assembly connects the traction grouser to the track of the vehicle.

### CROSS-REFERENCE TO RELATED APPLICATION

This application is a continuation-in-part of U.S. Utility application Ser. No. 10/313,877, filed on 5 Dec. 2002, and entitled “Grouser Assembly”, the benefit of which is hereby claimed under 35 USC §119, and the entirety of which is incorporated by reference herein.

### FIELD OF THE INVENTION

The present invention relates generally to grousers for tracked vehicles, and specifically to grousers that are selectively deployable.

### BACKGROUND OF THE INVENTION

Ground-engaging endless track chain assemblies have long been employed to provide ground contact for vehicles used in construction, fighting of forest fires, logging, and other demanding off-road pursuits. The track chain assemblies, and particularly the individual track shoes thereof, have experienced considerable research development. Standard track shoes consist of a steel plate with single, double, or triple grousers or cleats running across its width. While this generally affords good traction, such single grouser track shoes do not provide adequate traction on steep slopes, or ground that is frozen or extremely muddy.

Not surprisingly, a variety of solutions have arisen in attempting to accommodate this problem by changing grouser configuration on the track links themselves. For example, U.S. Pat. No. 4,637,665 to Burdick is directed to a track assembly for a track-type vehicle having a plurality of first and second distinct individual track shoes joined together to form an endless loop. The first shoes have a projecting grouser bar which has a first plurality of teeth and the second shoes have a projecting grouser bar which has a second plurality of teeth. The first and second shoes are arranged in an alternating pattern with the teeth of the first shoes staggered relative to the teeth of the second shoes. Conventional grousered track shoes generally provide track-type vehicles with sufficient surface traction for most work tasks of the vehicle. However, in some special work applications, the conventional grouser track shoes is inadequate to provide the required penetration to achieve sufficient tractive force. For such special work applications, the subject toothed grouser track shoes penetrate the surface and provide the necessary traction to effectively perform the work function.

U.S. Pat. No. 4,805,968 to Connerley deals with a track shoe for use with a track-laying vehicle. The shoe includes a cast body portion having three bored lug segments spaced along the front of the shoe and a pair of bored lug segments spaced along the rear of the shoe. The cast body portion has a fin-like guide member for engagement with sprocket and bogey wheels. Pairs of reinforcing ribs extend lengthwise along the shoe which form the longitudinal sides of sprocket tooth engaging openings. A single grouser extends along the width of the shoe to reinforce the body portion and to provide traction between the shoe and ground as the vehicle moves along a terrain. The grouser member and the rear lugs form the leading sides and the trailing sides of the sprocket tooth openings, respectively.

U.S. Pat. No. 3,964,797 to Swanson shows a track shoe with staggered grousers includes an elongated rectangular planar body portion with a predetermined leading edge, a trailing edge, a pair of side edges and a flat outer wear surface thereon and having a leading grouser extending integrally outwardly from the wear surface in parallel juxtaposed relation to the leading edge centrally thereof, and with a pair of laterally spaced trailing grousers extending integrally outwardly from the wear surface in parallel juxtaposed relation to the trailing edge and laterally inwardly from the side edges, to cause adhering mud or the like to be released from entrapment between the leading grouser, the trailing grousers and the wear surface of the planar body portion for improved penetration and traction.

The above approaches involve replacement of the shoes in the tracks, requiring at least partial disassembly and reassembly of track. It is also known to weld auxiliary grousers directly onto the track shoes. The time and effort required to so equip a tracked vehicle is prohibitive. Furthermore, when the grousers are either worn out or no longer desired, they must be removed with a cutting torch or similar implement, resulting in additional equipment downtime.

Both built-in and welded-on grousers entail long installation times, often taking a vehicle out of service for at least a day or more. It can be seen from the foregoing that the need exists for simple, inexpensive grouser assembly that overcomes the difficulties of known systems.

### SUMMARY OF THE INVENTION

A detachable grouser assembly for use with vehicles having continuous flexible tracks includes a traction grouser adapted and constructed to fit onto a track of the vehicle. A selectively releasable mechanical attachment assembly connects the traction grouser to the track of the vehicle.

### DESCRIPTION OF THE DRAWINGS

FIG. 1 is a schematic side elevational assembly view of an embodiment of a grouser assembly in accordance with the principles of the present invention.

FIG. 2 is a sectional view of the FIG. 1 grouser assembly taken generally along lines II-II.

FIG. 3 is a sectional view of the FIG. 1 grouser assembly taken generally along lines III-III.

FIG. 4 is a sectional view of the FIG. 1 grouser assembly taken generally along lines IV-IV.

FIG. 5 is a schematic side elevational view of the FIG. 1 grouser assembly installed on a track section.

FIG. 6 is a schematic side elevational assembly view of an embodiment of a grouser assembly in accordance with the principles of the present invention.

FIG. 7 is a sectional view of the FIG. 6 grouser assembly taken generally along lines VII-VII.

FIG. 8 is a sectional view of the FIG. 6 grouser assembly taken generally along lines VIII-VIII.

FIG. 9 is a sectional view of the FIG. 1 grouser assembly taken generally along lines IX-IX.

FIG. 10 is a schematic side elevational assembly view of an embodiment of a grouser assembly in accordance with the principles of the present invention.

FIG. 11 is a sectional view of the FIG. 10 grouser assembly taken generally along lines XI-XI.

FIG. 12 is a sectional view of the FIG. 10 grouser assembly taken generally along lines XII-XII.

FIG. 13 is a sectional view of the FIG. 10 grouser assembly taken generally along lines XIII-XIII.

FIG. 14 is a schematic side elevational view of the FIG. 10 grouser assembly installed on a track section.

FIG. 15 is a schematic side elevational view of an embodiment of a cork element in accordance with the principles of the present invention.

### DETAILED DESCRIPTION OF THE INVENTION

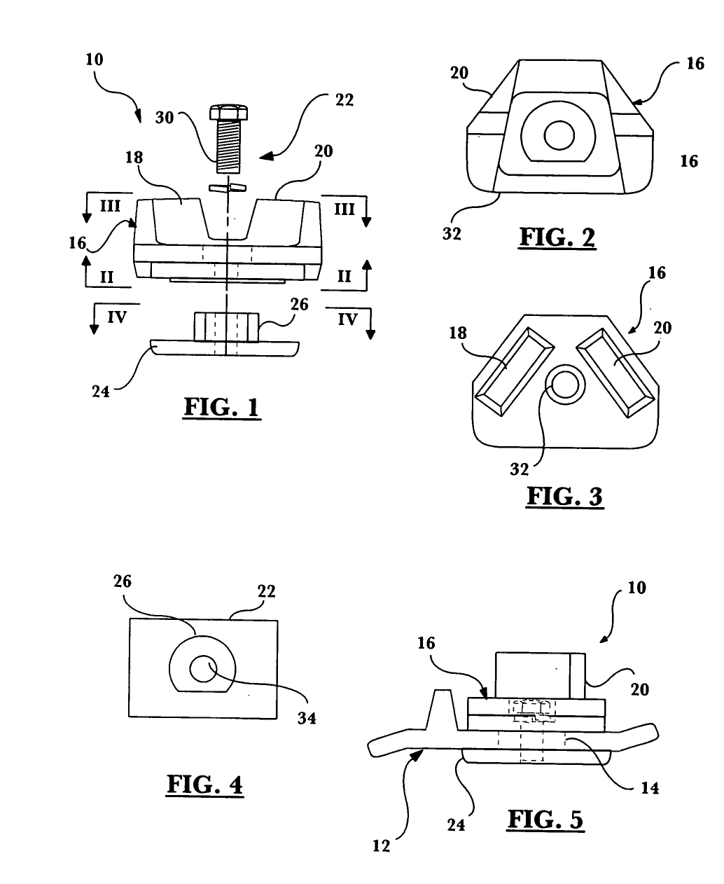

FIGS. 1-5 illustrate a grouser assembly 10 representing one embodiment of the present invention. The grouser assembly 10 is adapted for attachment to a section or shoe 12 of a flexible track of tracked vehicle. The track section 12 has a plurality of clean-out holes 14 in standard arrangements. The shape and number of clean-out holes can vary. The grouser assembly 10 includes a traction grouser 16 having a contour that enhances the ability of the track section 12 to grip into surfaces traversed by the tracked vehicle. Here, the traction grouser 16 includes outwardly-extending raised traction elements 18, 20 arranged in an open chevron configuration, although it is contemplated that the placement of traction elements will be dictated by the nature of the terrain to be traversed by the vehicle.

The traction grouser 16 is secured to the track section 12 by a selectively releasable mechanical attachment assembly 22. The attachment assembly 22 includes a mounting plate 24 secured on a surface of the track section 12 opposite the surface upon which the traction grouser 16 is mounted. The mounting plate 24 includes a securing member 26 configured in shape and height to extend through one of the clean-out holes 14. In this embodiment, the traction grouser 16 is provided with a bore 28 adapted to receive the securing member 26. A threaded bolt assembly 30, including a bolt and lock washer, extends through a bore 32 in the traction grouser 16 to a threaded bore 34 in the securing member 26 of the mounting plate 24. In operation, the traction grouser 16 is placed on the track section 12, and the threaded bolt assembly 30 is placed through the traction grouser 16 and the clean-out hole 14. As shown in FIG. 5, the threaded bolt assembly 30 is then secured to the mounting plate 24, via a threaded bore in the mounting plate itself as described, or by threaded nuts (not shown).

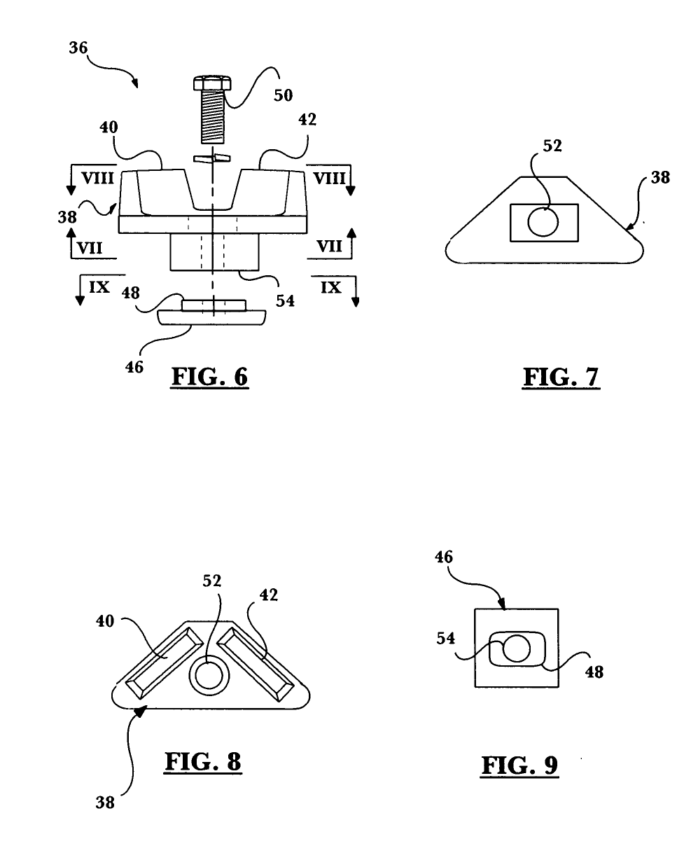

FIG. 7 illustrates a grouser assembly 36 representing another embodiment of the present invention. The grouser assembly 36 is adapted for attachment to a section of a flexible track of tracked vehicle, the sections having a plurality of clean-out holes as in the previous embodiment. The grouser assembly 36 includes a traction grouser 38 having a contour that enhances the ability of the track section to grip into surfaces traversed by the tracked vehicle. Here, the traction grouser 38 is generally triangular in shape, and includes outwardly-extending raised traction elements 40, 42 arranged in an open chevron configuration.

The traction grouser 38 is secured to the track section by a selectively releasable mechanical attachment assembly 44. The attachment assembly 44 includes a mounting plate 46 secured on a surface of the track section opposite the surface upon which the traction grouser 38 is mounted. The mounting plate 46 includes a securing member 48 configured in shape and height to extend through one of the clean-out holes of the track. A threaded bolt assembly 50, including a bolt and lock washer, extends through a bore 52 in the traction grouser 38 to a threaded bore 54 in the mounting plate 46. In operation, the traction grouser 38 is placed on the track section, and the threaded bolt assembly 50 is placed through the traction grouser 38 and the clean-out hole. The threaded bolt assembly 50 is then secured to the mounting plate 46, via a threaded bore in the mounting plate itself as described, or by threaded nuts (not shown).

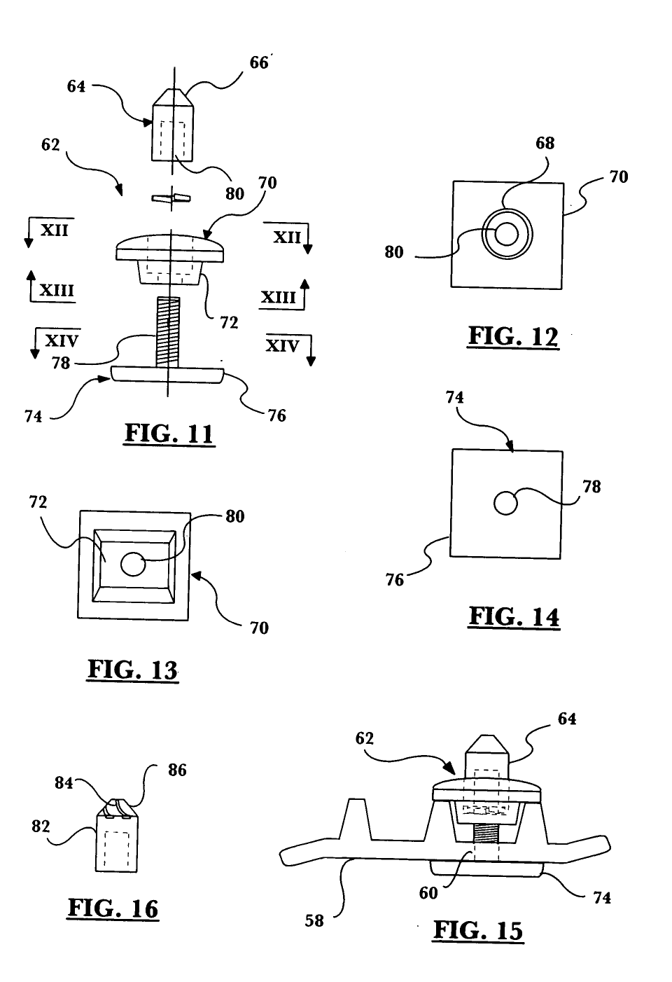

Another embodiment of the present invention is illustrated in FIGS. 11-15, in which a grouser assembly 56 is adapted for attachment to a section 58 of a flexible track of the tracked vehicle. The track section 58 has a plurality of clean-out holes 60 in standard arrangements. The shape and number of clean-out holes can vary. The grouser assembly 56 includes a traction grouser 62 having a contour that enhances the ability of the track section 58 to grip into surfaces traversed by the tracked vehicle. Here, the traction grouser 62 includes an outwardly-extending, cylindrical cork element 64 having a pointed contact end 66. The cork element 64 is adapted to fit into a bore 68 of a mounting block 70. A securing member 72 extends from the mounting block 70, and is shaped to fit into the cleaning holes 60 of the track section 58. In a single or double grouser shoe, the outer dimensions of the mounting block 70 are configured to fit between the upstanding grouser bars of the track section 58. With a triple grouser shoe, the outer dimensions of the mounting block 70 is configured to fit atop the upstanding grouser bars of the track section 58. It may be necessary with some track shoes to provide an adapter plate to ensure optimal fit. Some track shoes are provided without clean-out holes. In such instances, a template is provided so that holes corresponding to the dimensions of clean-out holes can be cut into the shoes for the purpose of mounting traction grousers.

The traction grouser 62 is secured to the track section 58 by a selectively releasable mechanical attachment assembly 74. The attachment assembly 74 includes a mounting plate 76 secured on a surface of the track section 68 opposite the surface upon which the traction grouser 62 is mounted. The mounting plate 76 includes a threaded post 78 adapted to be received in a threaded bore 80 in the cork element 64. In operation, the mounting block 70 is placed on the track section 158, and the threaded post 78 is placed through the mounting block 70 and the clean-out hole 60. As shown in FIG. 5, the cork element 64 is then secured to the mounting plate 24 by threading it onto the post 78. Alternatively, the mounting plate 70 can be provided with a threaded bore, and the cork element 64 can be provided with a corresponding threaded post (not shown).

As seen in FIG. 16, the cork element 82 can be provided with additional traction-enhancing features. In the illustrated embodiment, these features take the form of spiral threaded grooves 84 cast or cut into the pointed end 86 of the cork element 82.

It is contemplated that sets of 16 or more grouser assemblies, mounted at evenly spaced intervals on each track of a vehicle, will provide optimal traction enhancement. In such an arrangement, with the grouser assemblies evenly spaced, at least three traction grousers will be in contact with the surface to be traversed at any given time. The grouser assemblies are replaceable and reusable.

It is also contemplated that the grouser assemblies of the present invention can be adapted to fit a variety of sizes of flexible track sections, and can to fit any flexible track configuration. Such modifications include, but are not limited to, different bolt patterns, various dimensions of grouser bars on the track, the size and number of bolts to fit clean-out hole patterns, varying spacer configurations. It is also contemplated that alternative securing mechanisms, such as lock pins, can be used in place of threaded bolts. Similarly, the grouser assemblies can be fabricated from any suitable materials providing sufficient durability, wear, and performance as required for particular applications.

Although the present invention has been described with reference to specific embodiments, those of skill in the art will recognize that changes may be made thereto without departing from the scope and spirit of the invention as defined by the appended claims.

What is claimed is:

1. A detachable grouser assembly for use with vehicles having continuous flexible tracks, the grouser assembly comprising the following:
a traction grouser adapted and constructed to fit onto a track of the vehicle; and
a selectively releasable mechanical attachment assembly connecting the traction grouser to the track of the vehicle through a hole in the track.

2. A grouser assembly in accordance with claim 1, wherein the flexible track includes a plurality of clean-out holes, and the selectively releasable mechanical attachment assembly is secured to the flexible track by insertion of a part of the grouser assembly through the clean-out holes.

3. A grouser assembly in accordance with claim 2, wherein the selectively releasable mechanical attachment assembly comprises the following:
a mounting plate; and
securing members extending through the clean-out holes and releasably connecting the mounting plate to the traction grouser.

4. A grouser assembly in accordance with claim 3, wherein the securing members comprise threaded bolt assemblies.

5. A grouser assembly in accordance with claim 3, wherein the traction member comprises raised traction elements.

6. A grouser assembly in accordance with claim 5, wherein the raised traction elements are configured in a chevron arrangement.

7. A grouser assembly in accordance with claim 5, wherein the raised traction elements comprises a cork member.

8. A grouser assembly in accordance with claim 7, further comprising a traction-enhancing feature on the cork element.

9. A grouser assembly in accordance with claim 8, wherein traction-enhancing feature comprises spiral grooves.

10. A reusable, detachable grouser assembly for use with vehicles having continuous flexible tracks, the grouser assembly comprising the following:
a traction grouser adapted and constructed to fit onto a first side of a track of the vehicle, the traction grouser having a contour that enhances the ability of the track section to grip into surfaces traversed by the tracked vehicle; and
a selectively releasable mechanical attachment assembly connecting the traction grouser to the track of the vehicle through a hole in the track, the attachment assembly including a mounting plate mounted on a second side of the track of the vehicle.

11. A grouser assembly in accordance with claim 1, wherein the flexible track includes a plurality of clean-out holes, and the selectively releasable mechanical attachment assembly is secured to the flexible track by insertion of a part of the grouser assembly through the clean-out hole.

12. A grouser assembly in accordance with claim 11, wherein the flexible track includes a plurality of clean-out holes, and the selectively releasable mechanical attachment assembly is secured to the flexible track by insertion of a part of the attachment assembly through the clean-out hole.

13. A grouser assembly in accordance with claim 11, wherein the flexible track includes a plurality of clean-out holes, and the selectively releasable mechanical attachment assembly is secured to the flexible track by insertion of a part of the traction grouser through the clean-out holes.

14. A grouser assembly in accordance with claim 11, wherein the selectively releasable mechanical attachment assembly comprises securing members extending through the clean-out holes and releasably connecting the mounting plate to the traction grouser.

15. A grouser assembly in accordance with claim 14, wherein the securing members comprise threaded bolt assemblies.

16. A grouser assembly in accordance with claim 10, wherein the traction member comprises raised traction elements.

17. A grouser assembly in accordance with claim 16, wherein the raised traction elements are configured in a chevron arrangement.

18. A grouser assembly in accordance with claim 16, wherein the raised traction elements comprises a cork member.

19. A grouser assembly in accordance with claim 18, further comprising a traction-enhancing feature on the cork element.

20. A grouser assembly in accordance with claim 19, wherein traction-enhancing feature comprises spiral grooves.
